(19) United States
(12) Patent Application Publication
(10) Pub. No.: US 2010/0096152 A1
(43) Pub. Date: Apr. 22, 2010

(54) LEVER TYPE OUTPUT SHAFT LOCKING DEVICE

(75) Inventor: Jung-Ching Chiu, Taoyuan (TW)

Correspondence Address: RABIN & Berdo, PC, 1101 14TH STREET, NW, SUITE 500, WASHINGTON, DC, 20005, US

(73) Assignee: TOP GEARBOX INDUSTRY CO., LTD.

(21) Appl. No.: 12/252,481

(22) Filed: Oct. 16, 2008

(51) Int. Cl. B23Q 5/00

(52) U.S. Cl. 173/4

(57) ABSTRACT

An output shaft locking device for a power tool includes a positioning ring having a circular inner periphery and an output shaft extends through the positioning ring. Two activation members are between the positioning ring and the output shaft. Each activation member has a first protrusion on a central portion of one side thereof, and a second protrusion and a third protrusion are on two ends of the other side thereof. The first protrusions of the two activation members contact the output shaft, and the second protrusions and the third protrusions face the circular inner periphery of the positioning ring. When the output shaft rotates clockwise, the activation members are pushed outward and the second protrusions contact the positioning ring which applies a reaction force to pivot the activation members so that the third protrusions contact the positioning member to lock the output shaft from rotation.

### BACKGROUND OF THE INVENTION

1. Field of the Invention

The present invention relates generally to an output shaft locking device for a power tool, and more particularly, to an output shaft locking device which locks the output shaft when no power is supplied.

2. The Prior Arts

A conventional power tool such as a power drill is powered by electric power which can be supplied by plugging with the receptacles, rechargeable battery or a switching device for employing either of the two aforementioned ways to provide power. When there is power supplied, the power drill can be directly connected with the power source such as the AC power. When there is no AC power available, or the cord is too short to reach the receptacles, the rechargeable battery is an ideal solution. However, the rechargeable battery can only provide limited voltage which cannot drive the power drill for a longer time and it takes a lot of time to recharge the battery. When no power can be used, the user has to rotate the output shaft manually.

The conventional power drill includes a drive gear on a spindle of a motor and the drive gear is engaged with a gear set which is engaged with a follower gear on the output shaft. When the user wants to rotate the output shaft manually, the follower gear performs as a drive gear and the force is transferred to the drive gear via the gear set. This makes the bit to rotate without output torque so that the drill cannot actually output torque to drill a hole.

Besides, a chuck of the conventional power tool is connected with the output shaft and includes multiple claws and a rotatable collar co-axially connected to the output shaft. The rotation of the rotatable collar moves the claws toward the output shaft to clamp the bit, or away from the output shaft to release the bit. It requires the user to operate the rotatable collar by one hand and the other hand holds the fixed end of the output shaft. This is not convenient for the users.

Taiwanese Patent Publication Nos. 410714 and 334869 provide a locking device to solve the shortcomings of the conventional power tool and the locking device includes a positioning ring with multiple beads located between an inner periphery of the positioning ring and the output shaft. When the output shaft is rotated, the beads contact the positioning ring and lock the output shaft. Nevertheless, the positioning ring and the output shaft may not be precisely installed to have the same axis; the beads cannot be pushed evenly, so that the locked status is not reliable.

### SUMMARY OF THE INVENTION

A primary objective of the present invention is to provide an output shaft locking device to solve the shortcoming of the beads not evenly pushed to contact the positioning ring to affect the locked status of the output shaft.

The present invention provides multiple activation members pivotably located between the positioning ring and the output shaft. The activation members replace the beads in the conventional locking device. When the output shaft rotates, the activation members are pivoted by the reaction forces from the positioning ring so that the activation members are evenly applied by a locking force and the output shaft cannot rotate even if the positioning ring and the output shaft does not precisely share a common axis.

The solution of the present invention is to provide an output shaft locking device for a power tool and the locking device comprises a positioning ring having a circular inner periphery and an output shaft having a regular polygon cross section extends through the positioning ring. At least two activation members are located between a circular inner periphery of the positioning ring and the output shaft. Each of the at least two activation members has a first protrusion on a central portion of one side thereof, and a second protrusion and a third protrusion are on two ends of the other side of each of the at least two activation members. The first protrusion of the at least two activation members contacts the output shaft. The second protrusion and the third protrusion face the circular inner periphery of the positioning ring. When the output shaft rotates, the activation members are pivoted by the reaction forces from the positioning ring so that the activation members are evenly applied by a locking force and the output shaft cannot rotate.

The output shaft locking device of the present invention provides a reliable locking feature even if the positioning ring and the output shaft does not precisely share a common axis.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a cross sectional view to show an output shaft locking device in accordance with the present invention;

FIG. 2 shows an end view taken along line II-II in FIG. 1;

FIG. 3A shows an end view taken along line IIIA-IIIA in FIG. 1;

FIG. 3B shows that a second protrusion of an activation member contacts an inner periphery of a positioning ring when the output shaft rotates;

FIG. 3C shows that the positioning ring applies a reaction force to the second protrusion of the activation member to pivot the activation member, so that a third protrusion of the activation member contacts the inner periphery of the positioning ring; and

FIG. 3D shows that the positioning ring is locked when the second and third protrusions of the activation members contact the inner periphery of the positioning ring.

### DETAILED DESCRIPTION OF THE PREFERRED EMBODIMENT

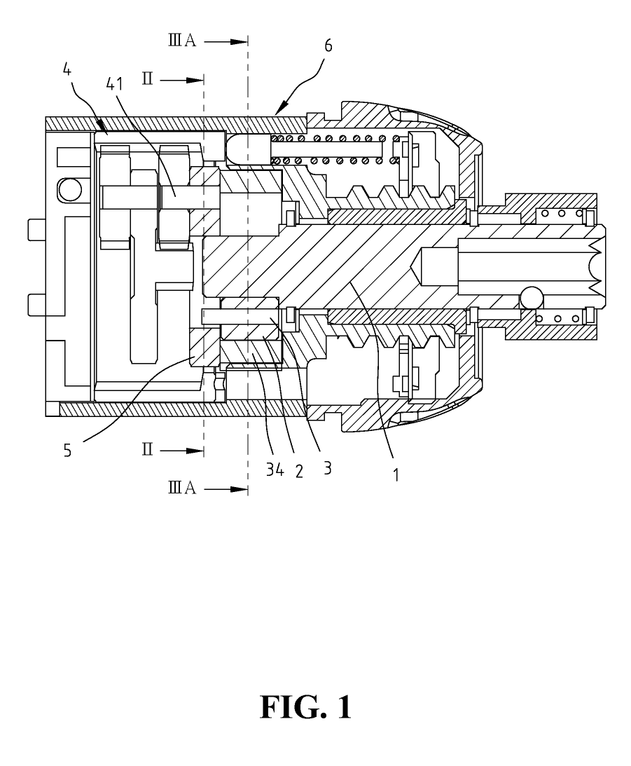

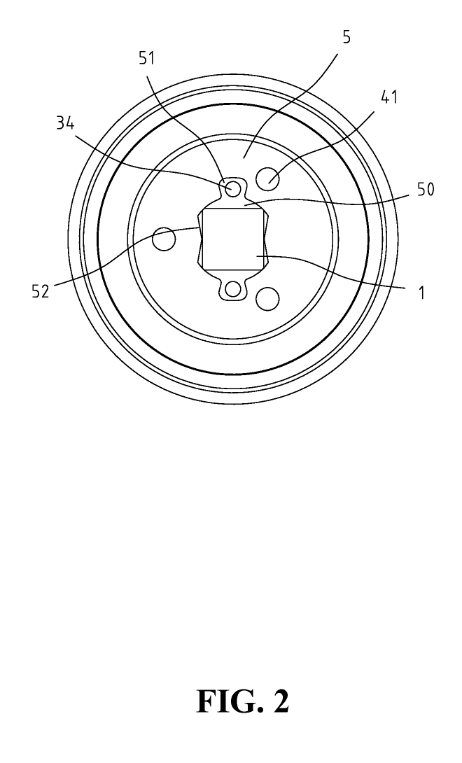

With reference to the drawings and in particular to FIGS. 1 and 2, an output shaft locking device in accordance with the present invention comprises an output shaft 1 which is received in a casing 6 of the power tool and bearings are mounted to the output shaft 1 which is freely rotatable. The front end of the output shaft 1 extends out from the casing 6 so as to be connected with tool bits such as screw bits and drills. A positioning ring 2 and at least two activation members 3 are received in the casing 6. A reduction gear set 4 is located in a rear end of the casing 6 and connected with a motor (not shown). The gear set 4 further is connected to a driving disk 5 by pins 41 and the driving disk 5 has a central hole 50 which includes two recesses 51 defined in an inner periphery thereof. The two recesses 51 are separated by 180 degrees of angular distance. Two pie-shaped protrusions 52 extend inward from the central hole 50 and located at 90 degrees of angular distance from the two recesses 51. The output shaft 1 has a regular polygon cross section and in this embodiment, the output shaft 1 has a square cross section and extends through the positioning ring 2 and the central hole 50 of the driving disk 5. The positioning ring 2 includes a circular inner periphery. The at least two activation members 3 are located on two opposite sides of the output shaft 1. The at least two activation members 3 are located within a space enclosed by the circular inner periphery of the positioning ring 2.

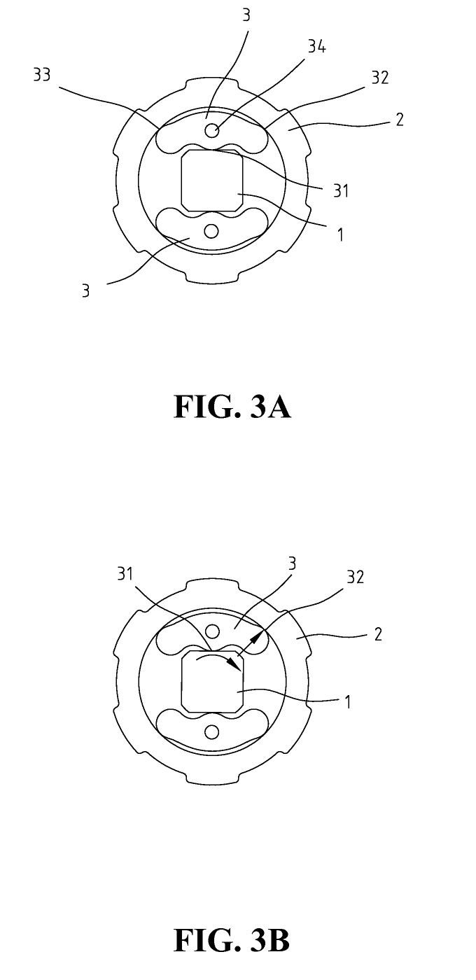

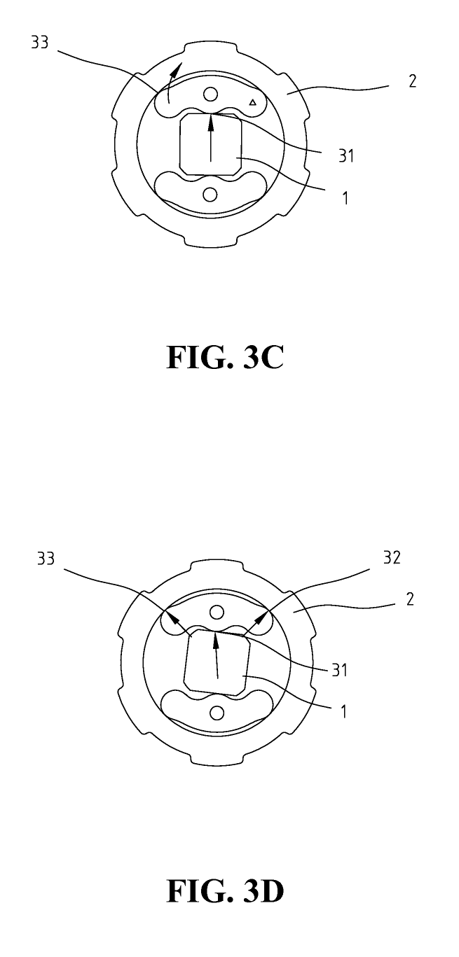

With reference to FIG. 3A, each of the at least two activation members 3 is a curved block and has a first protrusion 31 on a central portion of one side thereof, a second protrusion 32 and a third protrusion 33 are on two ends of the other side of each of the at least two activation members 3. A pin 34 extends through a center of the activation member 3 so that the activation members 3 are pivotable about the pins 34. The pins 34 are located within the recesses 51 of the driving disk 5. The first protrusion 31 of the at least two activation members 3 contacts the output shaft 1, the second protrusion 32 and the third protrusion 33 face the circular inner periphery of the positioning ring 2.

When the output shaft 1 rotates to drive a bit, the motor drives the gear set 4 which drives the driving disk 5. Whichever direction the driving disk 5 rotates, the pie-shaped protrusions 52 contact the output shaft 1 so as to drive the output shaft 1. The rotation of the driving disk 5 drives the pins 34 so that the activation members 3 are rotated within the stationary positioning ring 2.

As shown in FIG. 3B, when the motor does not activate and the user wants to rotate the output shaft 1 without electric power supplied, assuming that the output shaft 1 is rotated clockwise, the activation members 3 are pushed outward because the first protrusions 31 are pushed by the output shaft 1. The second protrusions 32 contact the positioning ring 2 which applies a reaction force to pivot the activation members 3 so that the third protrusions 33 contact the positioning member 2 as shown in FIG. 3C. The second and third protrusions 32, 33 both contact the positioning ring 2 so that the output shaft 1 is locked from rotation as shown in FIG. 3D.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An output shaft locking device for a power tool, comprising:
a positioning ring having a circular inner periphery;
an output shaft having a regular polygon cross section and extending through the positioning ring; and
at least two activation members located within a space enclosed by the circular inner periphery of the positioning ring, each of the at least two activation members having a first protrusion on a central portion of one side thereof, a second protrusion and a third protrusion being on two ends of the other side of each of the at least two activation members, the first protrusion of the at least two activation members contacting the output shaft, the second protrusion and the third protrusion facing the circular inner periphery of the positioning ring.

2. The output shaft locking device as claimed in claim 1, wherein the output shaft has a square cross section and the at least two activation members are located on two opposite sides of the output shaft.
